(19) United States
(12) Patent Application Publication
(10) Pub. No.: US 2026/0079363 A1
(43) Pub. Date: Mar. 19, 2026

(54) GARAGE DOOR WITH SWITCHABLE GLASS/FILM FOR ON-DEMAND TRANSITION BETWEEN FULL VIEW AND PRIVACY

(71) Applicant: ASSA ABLOY Entrance Systems AB, Landskrona (SE)

(72) Inventors: Stephen Anthony Roesner, Lawrence, KS (US); Parag Pathak, Winston-Salem, NC (US); Neil Edwards, Kernersville, NC (US)

(21) Appl. No.: 18/888,110

(22) Filed: Sep. 17, 2024

(51) Int. Cl. G02F 1/133; E05D 3/02; E05D 15/22; E05F 15/668

(52) U.S. Cl. CPC G02F 1/13306; E05D 3/02; E05D 15/22; E05F 15/668; E05D 2015/225; E05Y 2201/684; E05Y 2201/688; E05Y 2900/106

(57) ABSTRACT

A sectional door may include a plurality of door sections including at least a top section and a bottom section, a hinge assembly operably coupling adjacent door sections to each other to enable the adjacent door sections to pivot relative to each other via the hinge assembly, a roller assembly operably coupling the door sections to a rail assembly to enable the sectional door to transition between an open state and a closed state via the roller assembly carrying the sectional door in the rail assembly, and a switchable viewing pane that transitions between a transparent state and an opaque or translucent state responsive to receipt of a transition signal, the switchable viewing pane being disposed at a portion of one of the door sections.

### TECHNICAL FIELD

Example embodiments generally relate to movable sectional doors, such as garage doors and, in particular, relate to a sectional door having switchable viewing panes that can transition between full view and privacy modes.

### BACKGROUND

Moveable sectional doors, such as garage doors, have often been made with a relatively light metal, and therefore can be moved between open and closed positions with less power required. Some sectional doors have had portions of metal replaced with glass or film to allow natural light to pass through. This glass or film can either be selected to be transparent, thereby permitting two-way visibility through the glass or film, or to be opaque or translucent, thereby not permitting visibility although perhaps permitting some amount of light to pass. These choices have typically remained binary, and must be made when purchasing the door, and are not easily changeable thereafter.

Meanwhile, office environments, homes and other locations have sometimes employed switchable glass or film, which can be transitioned between being transparent and opaque/translucent via electronic control. The structure of fixed windows in these environments tends to make it relatively easy to provide power and electrical connectivity to enable control over the switching between states. However, because of the moving nature of the sectional doors in garage door and similar environments, it has not been practical to attempt to employ switchable glass or film in such contexts.

### BRIEF SUMMARY OF SOME EXAMPLES

In an example embodiment, a sectional door with switchable viewing properties may be provided. The sectional door may include a plurality of door sections including at least a top section and a bottom section, a hinge assembly operably coupling adjacent door sections to each other to enable the adjacent door sections to pivot relative to each other via the hinge assembly, a roller assembly operably coupling the door sections to a rail assembly to enable the sectional door to transition between an open state and a closed state via the roller assembly carrying the sectional door in the rail assembly, and a switchable viewing pane that transitions between a transparent state and an opaque or translucent state responsive to receipt of a transition signal, the switchable viewing pane being disposed at a portion of one of the door sections.

In another example embodiment, garage door operator (GDO) system may be provided. The GDO system may include a sectional door movable on rails between an open position and a closed position, and a motorhead operable to provide power for movement of the sectional door between the open and closed positions. The sectional door may include a plurality of door sections including at least a top section and a bottom section, a hinge assembly operably coupling adjacent door sections to each other to enable the adjacent door sections to pivot relative to each other via the hinge assembly, a roller assembly operably coupling the door sections to the rails to enable the sectional door to transition between the open position and the closed position via the roller assembly carrying the sectional door in the rails, and a switchable viewing pane that transitions between a transparent state and an opaque or translucent state responsive to receipt of a transition signal, in which the switchable viewing pane is disposed at a portion of one of the door sections.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a GDO system in a ceiling mounted or trolley in accordance with an example embodiment;

FIG. 2A illustrates a cross section view of a switchable viewing pane in an off (opaque/translucent) state in accordance with an example embodiment;

FIG. 2A illustrates a cross section view of the switchable viewing pane in an on (transparent) state in accordance with an example embodiment;

FIG. 3 is a block diagram of a switchable viewing pane control system according to an example embodiment;

FIG. 4 illustrates a display of a user interface for opening/closing the sectional door and for adjusting transparency of the viewing panes of the sectional door in accordance with an example embodiment;

FIG. 5A shows a sectional door with a floor-mounted charging interface and all switchable viewing panes in a transparent state according to an example embodiment;

FIG. 5B shows the sectional door of FIG. 5A with all switchable viewing panes in an opaque state according to an example embodiment;

FIG. 5C shows the sectional door of FIG. 5A with only switchable viewing panes in a single section of the sectional door being in a transparent state according to an example embodiment;

FIG. 5D shows the sectional door of FIG. 5A with individual switchable viewing panes in different sections of the sectional door being in a transparent state according to an example embodiment; and

FIG. 6 illustrates a perspective view of a rail-mounted charging interface for a switchable viewing pane control system in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, switchable glass or film has not been practically deployable in a garage door context due to the moving nature of the door. Furthermore, garage door environments typically include some (or at least increased) exposure to weather and debris. Thus, for example, the provision of power and the controlling of state switching for a movable component in such an environment have presented challenges to practicality to date. Example embodiments may provide multiple solutions to these general problems, and may therefor provide a paradigm shift in relation to garage door system sales channels. In this regard, for example, rather than requiring two separate supply chains for doors having windows that are either transparent or opaque/translucent, one combined product with the capability of switching states may instead be provided.

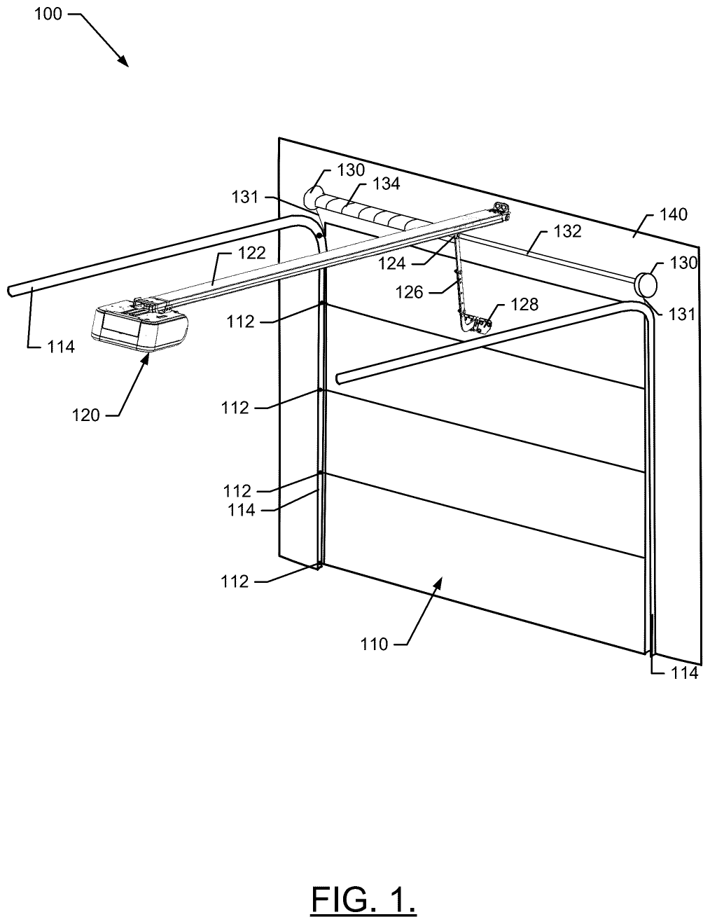

FIG. 1 illustrates a garage door operator (GDO) system 100 of an example embodiment. In this regard, FIG. 1 shows the GDO system 100 in a trolley (or ceiling mounted) configuration, but it should be understood that example embodiments may also apply to situations in which the GDO system 100 is in a jackshaft configuration. In both cases, the GDO system 100 includes a sectional door 110, in which each section of the door has rollers 112 operably coupled to opposing lateral sides of the sections. The rollers 112 are typically rotatably operably coupled to the sectional door 110 via brackets that rotatably support a shaft of the rollers 112 and enable a wheel to extend into and ride within rails 114 disposed on opposing sides of the sectional door 110 as the sectional door 110 transitions between open and closed positions. The sectional door 110 of FIG. 1 is shown in the closed position, where the rollers 112 are in a vertical section of the rails 114. Thus, it can be appreciated that in the open position the rollers 112 are located in a horizontally extending portion of the rails 114, and the sectional door 110 is carried into parallel with the ground as opposed to its condition of being perpendicular to the ground in the closed position shown in FIG. 1. Each section of the sectional door 110 can pivot relative to any adjacent section at an intersection thereof in order to enable the sectional door 110 to traverse the bend that separates the horizontally extending portion of the rails 114 from the vertically extending portion of the rails 114.

FIG. 1 also illustrates a GDO unit referred to as an opener 120 or motorhead. The opener 120 of this example is shown in the trolley configuration in which a guide rail 122 may extend parallel to and approximately midway between the horizontally extending portion of the rails 114 on opposing lateral sides of the sectional door 110. The opener 120 may be mounted (e.g., from the ceiling) proximate to an end of the guide rail 122 to drive a trolley 124 along the guide rail 122 via a flexible member such as a belt, cable or chain. The belt, cable or chain may also be operably coupled (e.g., via the trolley 124) to a top portion of the sectional door 110 by an engaging arm 126 and engaging bracket 128 that is attached to the sectional door 110. As noted above, the trolley 124 may be manually released from the sectional door 110 to allow for manual repositioning of the sectional door 110.

In some cases, the sectional door 110 may also be supported by one or more instances of cables 131 that are alternately wound onto and off of one or more cable drums 130 disposed at or near opposing ends of a tube 132 (sometimes called a drive tube). The cables 131 may be attached to a bottom portion of the sectional door 110 to assist in carrying the weight of the sectional door 110. The tube 132 may further support a spring assembly 134 that facilitates, along with the cables 131, supporting the weight of the sectional door 110 during opening and closing operations of the sectional door 110 using the opener 120. The sectional door 110, when closed, may block an opening provided in a front wall 140 of the garage in which the GDO system 100 is installed. The opening may be left open when the sectional door 110 is raised onto the horizontally extending portions of the rails 114. As can be seen in FIG. 1, the guide rail 122 may be secured to the front wall 140 at a proximal end of the guide rail 122, and the opener 120 may be suspended from the ceiling of the garage at a distal end of the guide rail 122.

The sectional door 110 is, as noted above, often comprised of panels of aluminum, steel, fiberglass, plastic, or other relatively lightweight, but otherwise structurally rigid material of any suitable type. In some cases, one or more of the panels of the sectional door 110 may include or be comprised of a glass or film that may be transparent or translucent to allow natural light to pass therethrough and into the garage. As noted above, in an example embodiment, any one or more of the panels of the sectional door 110 may be provided with a switchable viewing pane as described herein. The switchable viewing pane may be transitioned between a transparent state and a translucent/opaque state by virtue of the application of a transition signal or instruction.

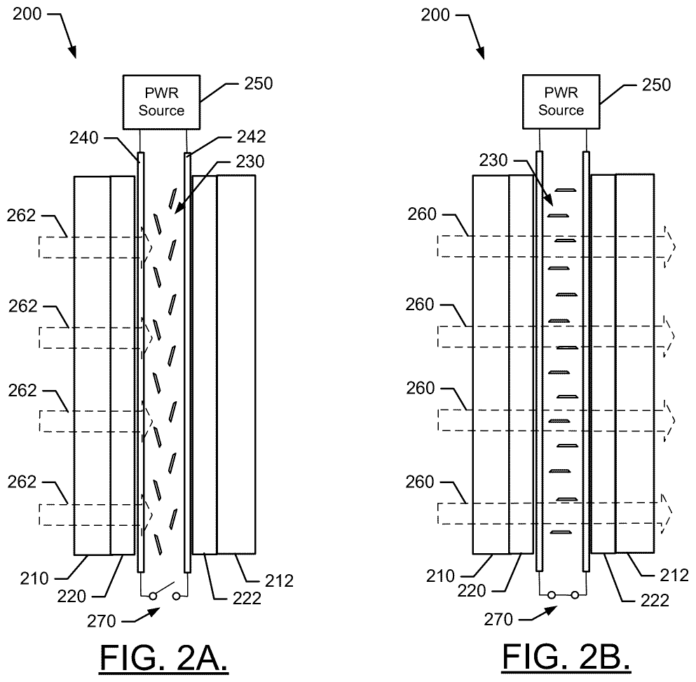

FIGS. 2A and 2B illustrate operation of a switchable viewing pane 200 in each of an opaque/translucent state (see FIG. 2A) and a transparent state (see FIG. 2B) in accordance with an example embodiment. Referring first to FIG. 2A, the switchable viewing pane 200 may include a first transparent sheet 210 and a second transparent sheet 212 that may contain therebetween the switchable components that enable the switchable viewing pane 200 to operate as intended. In an example embodiment, the first and second transparent sheets 210 and 212 may each be made of glass. However, other transparent and rigid materials such as polycarbonate, acrylic (e.g., plexiglass) or other transparent polymers may be sued instead of glass in some cases.

Sandwiched between the first and second transparent sheets 210 and 212, a first film layer 220 and a second film layer 222 may be provided to contain a liquid crystal material 230. The first and second film layers 220 and 222 may include one or more film layers that are transparent, and may include a liquid crystal film in some cases. The first and second film layers 220 and 222 may be adjacent to the first and second transparent sheets 210 and 212, respectively. Moreover, a first conductive member 240 and a second conductive member 242 may also be provided adjacent to the first and second film layers 220 and 222, respectively. The first and second conductive members 240 and 242 may, in some cases, be embodied as a conductive coating or film layer that may be provided on internal surfaces of the first and second film layers 220 and 222, respectively. Thus, the liquid crystal material 230 may also be disposed between the first and second conductive members 240 and 242.

As shown in FIGS. 2A and 2B, the first and second conductive members 240 and 242 may be capable of being operably coupled (e.g., electrically connected) to a power source 250. The power source 250 may be alternately be connected or disconnected (shown in FIG. 2A) electrically from the first and second conductive members 240 and 242. When connected (as shown in FIG. 2B) to the power source 250, an electric field may be generated between the first and second conductive members 240 and 242 that aligns molecules within the liquid crystal material 230 to permit light (represented by arrows 260) to pass entirely through the switchable viewing pane 200. However, when not electrically connected (as shown in FIG. 2A), the molecules of the liquid crystal material 230 may be unaligned and randomly dispersed, which may prevent light (represented by arrows 262) from passing through the liquid crystal material 230. The permissive state in which light is allowed to pass through the switchable viewing pane 200 may render the switchable viewing pane 200 transparent (or in a transparent state) and is shown in FIG. 2B. The non-permissive (or light blocking or inhibiting) state in which light is not allowed to freely pass through the switchable viewing pane 200 may render the switchable viewing pane 200 either translucent or opaque (or in a translucent or opaque state) and is shown in FIG. 2A.

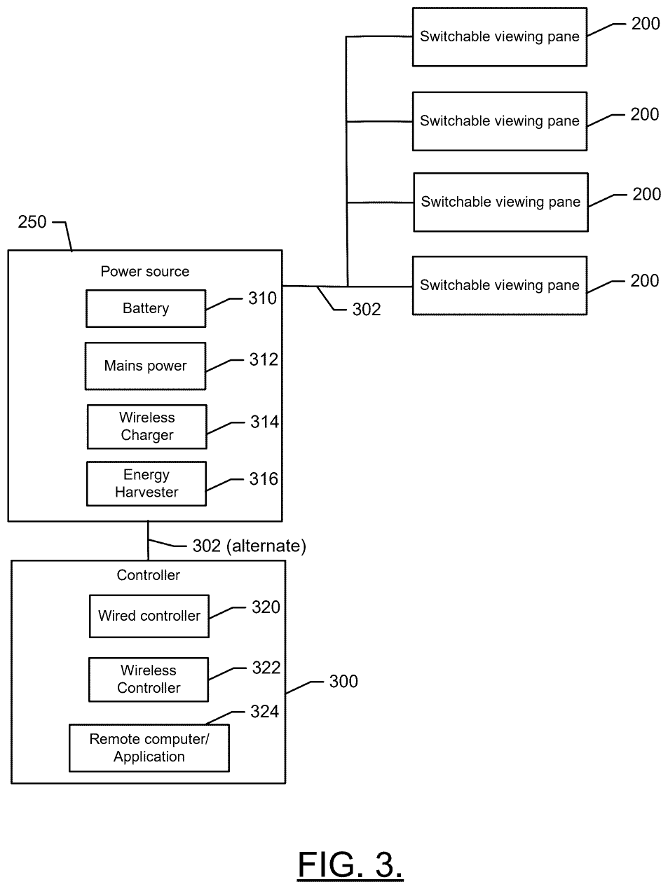

Notably, in FIGS. 2A and 2B, a switch 270 is shown to illustrate a device capable of providing or interrupting power from the power source 250 to the first and second conductive members 240 and 242. However, it may instead be possible to simply turn the power source 250 on or off and control power application that way, or in another alternative way, and thus, the switch 270 may simply be a functional representation of a means by which to control power application from the power source 250, and the switch 270 may not be a separate physical component in some cases. The switch 270 is opened to interrupt provision of power from the power source 250 to the first and second conductive members 240 and 242, and the switch 270 is closed to provide power from the power source 250 to the first and second conductive members 240 and 242. The switch 270, if included, may be electrically operable via either wired or wireless communication from a controller. A further description of the application of power from the power source 250 and means for controlling the same will be discussed below in reference to FIG. 3.

Turning now to FIG. 3, the power source 250 is shown operably coupled to multiple instances of the switchable viewing pane 200, and operates under control of a controller 300 to provide a transition signal 302 to transition the switchable viewing panes 200 between states. However, it should be appreciated that the power source 250 could be operably coupled to only a single instance of the switchable viewing pane 200 or any other number including more or fewer than the four shown in the example of FIG. 3. Furthermore, the switchable viewing panes 200 may each be in one panel of the sectional door 110, or may be split amongst different panels of the sectional door 110. Moreover, one instance of the power source 250 may power all instances of the switchable viewing panes 200, or multiple instances of the power source 250 may power respective different instances (or groups of instances) of the switchable viewing panes 200.

The power source 250 may also take many different physical forms. In this regard, for example, the power source 250 may be one or more instances of a battery 310. The battery 310 may be rechargeable or replaceable in various different embodiments. As noted above, one instance of the battery 310 may power each respective one of the switchable viewing panes 200. Alternatively, one instance of the battery 310 may power all instances of the switchable viewing panes 200 or groups thereof. When grouped, in some cases, all instances of the switchable viewing panes 200 that are located on the same panel of the sectional door 110 may be powered by one instance of the battery 310. When the power source 250 is embodied as the battery 310, the battery 310 may be physically disposed at, on or in the sectional door 110. Thus, for example, the battery 310 (or an instance thereof) may be located at a corresponding portion (i.e., panel) of the sectional door 110 to power some or all of the switchable viewing panes 200 located at the corresponding portion or panel of the sectional door 110.

As an alternative (or supplement) to battery power, the power source 250 may include mains power 312 via a corded connection. When mains power 312 is provided, the power supply being fixed, whereas the sectional door 110 is movable can create a challenge. However, in order to address this challenge, the corded connection may include wire that is wound up on a reel and therefore capable of being maintained through open/close cycles of the sectional door 110. In some embodiments, the cable 131 may be provided with power cord adjacent to or wrapped around the cable 131. In such a structure the drum 130 (or drums) may wind up the power cord simultaneously with winding up the cable 131 as the sectional door 110 opens and may allow the power cord to be withdrawn simultaneously with extension of the cable 131 while the sectional door 110 closes. A separate drum or reel dedicated to the power cord could alternatively be provided in some cases.

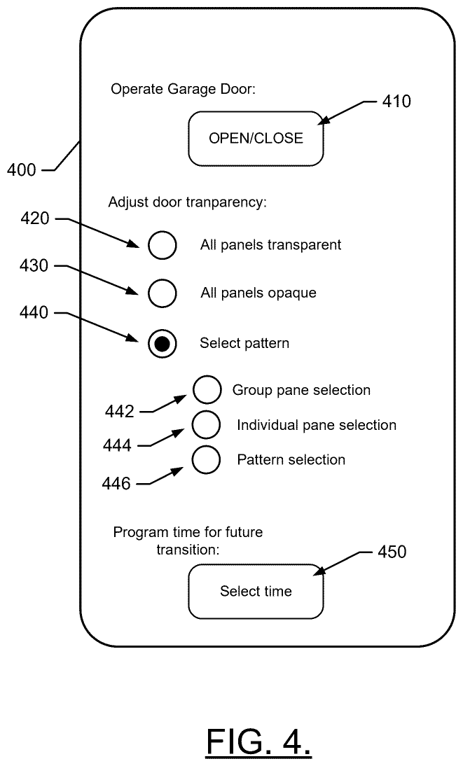

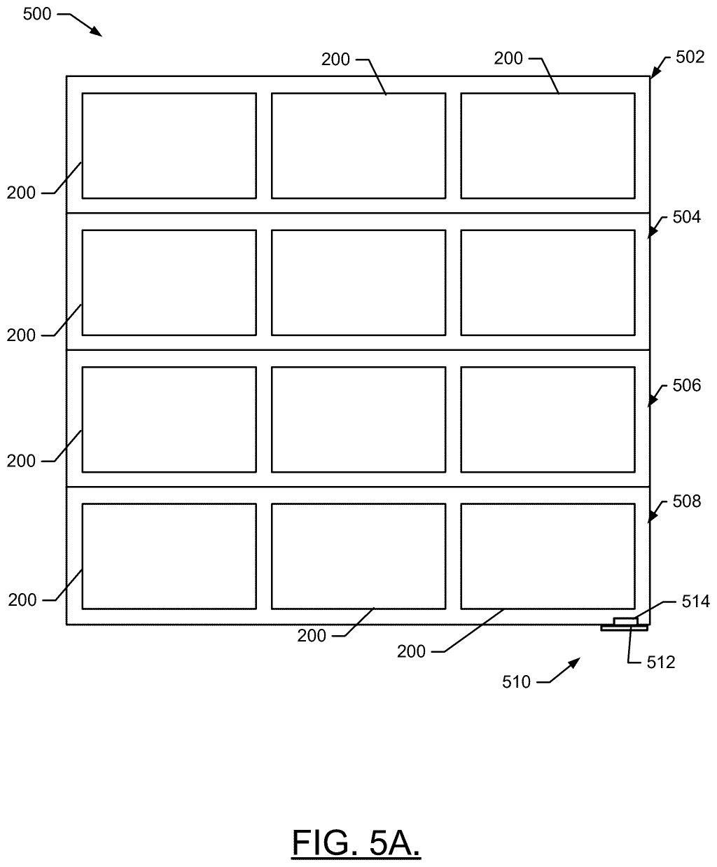

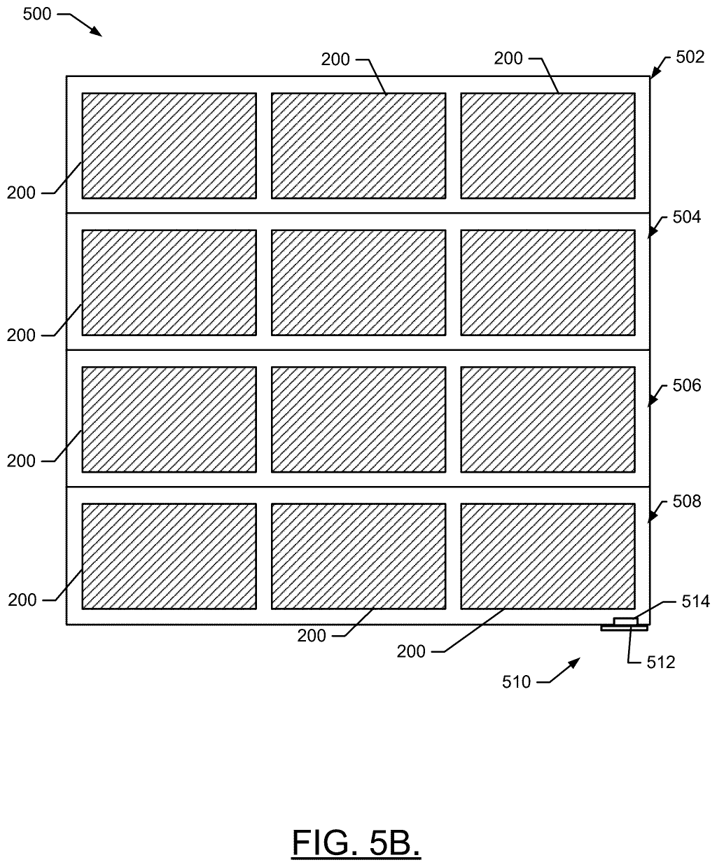

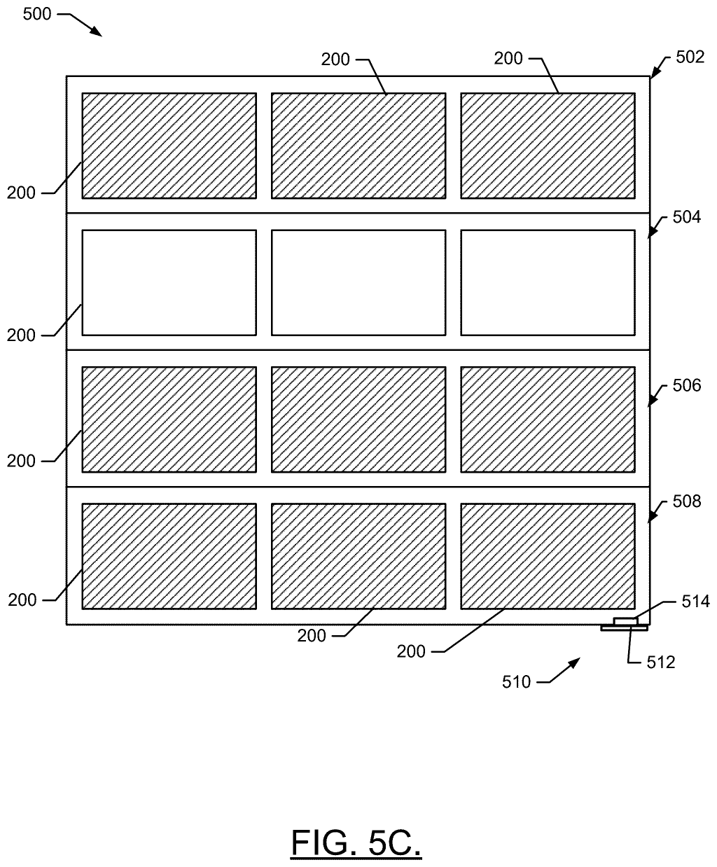

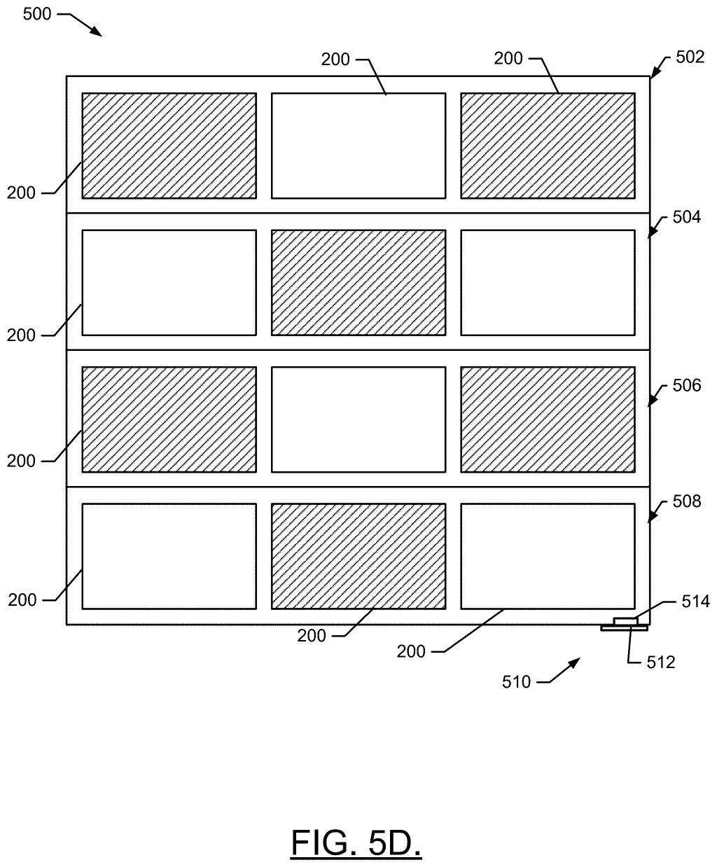

Although the battery 310 described above could be replaceable. In some cases, it may alternatively be rechargeable. When rechargeable, the battery 310 may be recharged when the sectional door 110 is located in a position that aligns the battery 310 with a corresponding charger (as shown for example in FIGS. 4 and 5). However, in some cases, the battery 310 may be charged via a wireless charger 314. In such cases, the battery 310 may be equipped with a receiver and analog-to-digital converter that takes wireless signals received at the receiver and converts them into a DC power for recharging the battery. The wireless charger 314 may provide wireless signals having sufficient power and in some cases also sufficient directivity to provide efficient power transfer to the battery 310 for recharging.

Since the sectional door 110 has moving and vibrating parts as an inherent part of its design. The use of an energy harvester 316 may also be provided to supplement or otherwise substitute for other charging means for the battery 310. In this regard, for example, the rollers 112, drums 130, or any other movable members of the GDO system 100 may include piezoelectric or other components that may convert motion or vibration of various components into electrical energy that may be used to charge or preserve charge of the battery 310 or otherwise assist in selective provision of power by the power source 250 to the switchable viewing panes 200. As will be appreciated by one of skill in the art, any combination of the examples shown in FIG. 3 for components of the power source 250 may also be employed in various example embodiments.

Turning to the controller 300, it may be appreciated that control of the power source 250 (and therefore also control of the state of the switchable viewing panes 200) may be provided by either a wired controller 320 or a wireless controller 322. The wired controller 320 may have a wired connection to the power source 250 and may alternately turn the power source 250 on or off, or otherwise interrupt power provided by the power source 250 to the switchable viewing panes 200. Thus, for example, the wired controller 320 may be disposed directly at the opener 120, or at a wall mounted wired controller of the opener 120 inside or outside the garage or other room to which the GSO system 100 provides access. In either case, the wired controller 320 may take the form of a selectable button, switch, keypad, or other operable member that, when pressed by the operator, causes the transition signal 302 to be communicated to one or more of the switchable viewing panes 200.

When power is provided to the switchable viewing panes 200, such power may act as the transition signal 302 mentioned above. However, in some cases, the transition signal 302 may be provided by the controller 300 to the power source 250 to operate the switch 270 or otherwise control the ability of the power source 250 to provide power to the switchable viewing panes 200. The transition signal 302 may be provided to the switchable viewing panes 200 individually or collectively either simultaneously (e.g., to selected panes that are to be made transparent) or in a delayed or programmed fashion (e.g., to create blinking or other effects desired by the user).

The wireless controller 322 may be a remotely operable controller that may, for example, communicate a wireless signal (e.g., the transition signal 302) to the power source 250 using short or long range wireless communication protocols. In some cases, the wireless controller 322 may be a separate or standalone controller configured only to change visibility through the switchable viewing panes 200. However, in other cases, the wireless controller 322 may also be used to operate the opener 120 to open/close the sectional door 110. Moreover, in some cases, the wireless controller 322 may be part of an application or app that is executable on a computing device capable of communicating with the power source 250 via wireless communication. However, such communication could alternatively be accomplished via wired connection. To illustrate both options, remote computer/application 324 is illustrated as another optional embodiment for the controller 300. An example of an interface screen 400 (or a control console or web page) for the remote computer/application 324 is shown in FIG. 4.

Of note, although the interface screen 400 of FIG. 4 shows an open/close button 410 on the same screen or page as options for adjusting door transparency and scheduling timing of transitions, these separate functions may alternatively be provided on separate pages. Regardless of where provided, the ability to adjust door panel transparency may be provided in a number of different ways, and may be controlled in various different control paradigms. As an example, a universal on (or transparent) selector 420 may be provided to select for all switchable viewing panes 200 to be made transparent. A universal off (or opaque) selector 430 may be provided to select all of the switchable viewing panes 200 to be made opaque. A pattern selector 440 or other selector for selecting individual pane control or at least less than all of the panes may also be provided. In some cases, a group pane selector 442 may be provided to enable groups of panes to be identified for selection. An individual pane selector 444 may be provided to enable individual panes to be turned on/off. As yet another alternative, a pattern selector 446 may be provided to enable various predetermined or user-defined patterns to be selected with respect to individual or groups of panes having any desired pattern. Timing selector 450 may be selected to program timing of changes so that they occur at predefined times in the future. The predefined times may include specific days and times at which the transition signal may be applied to change the viewing properties of selected ones of the switchable viewing panes 200. Thus, not only can a single time for future transition be selected, but patterns of transitioning may be defined across multiple days and times in the future.

In reference to the provision of power to the sectional door 110, which necessarily moves and therefore can create challenges for power provision, use of the battery 310 may be a popular choice. FIG. 4A shows one way to deal with the potential challenges of providing power to the sectional door 110. In some cases, an instance of the battery 310 (or even a group of batteries) may be provided for each individual one of the switchable viewing panes 200. However, in other cases, groups of switchable viewing panes 200 may be powered by respective instances of the battery 310. Furthermore, in some cases, one higher capacity instance of the battery 310 may power all of the switchable viewing panes 200.

Although the battery 310 may be replaceable in some cases, providing recharging capability is also desirable in many situations. Whereas rechargeable batteries may be removed for recharging, providing the ability to recharge the battery 310 without removing the battery 310 from being operably coupled to the controller 300 and/or the sectional door 110 may be desirable. Providing a means to charge the battery 310 in a movable context may therefore be a challenge in some cases. To address this challenge, recharging capability may be provided in one of the states (e.g., open or closed) of the sectional door 110. In particular, since it may be expected that most of the time the sectional door 110 will remain closed for security purposes, the closed state may be a good choice as the state in which charging is conducted.

FIG. 5A shows a sectional door 500 (as an example of sectional door 110) that includes a first section 502, a second section 504, a third section 506 and a fourth section 508 that are pivotally alleged to adjacent sections and that each include (in this example) three instances of the switchable viewing pane 200. Notably, more or fewer sections may be included, and more or fewer panes may be included in each section. In the example of FIG. 5A, all of the switchable viewing panes 200 are in the on or transparent state.

A floor-mounted charging interface 510 may be provided to charge an instance of the battery 310 that may be used to power one or more (including potentially all) of the switchable viewing panes 200 under operation of an instance of the controller 300 of FIG. 3. The floor-mounted charging interface 510 may include a charging pad 512 disposed on the floor of the garage or other room/building in which the sectional door 500 is located. The charging pad 512 may be powered by mains power (e.g., via wired connection), and may be positioned on the floor to be proximate to a charge adapter 514 disposed at a bottom portion of the bottom-most one of the sections (e.g., the fourth section 508 in this example). The charge adapter 514 and the charging pad 512 may include complementary charging electrodes that connect to each other when the sectional door 500 is in the closed position and enable electrical energy to be communicated to the charge adapter 514, which may then provide energy for charging the battery 310. However, in some cases, rather than charging electrodes, the charging pad 512 may include a power transformer primary winding or other wireless energy transmitter, and the charge adapter 514 may include a power transformer secondary winding or other wireless energy receiver, and wireless energy transfer for charging of the battery 310 may be accomplished by the charging interface 510 when the sectional door 500 is closed. In either case, AC to DC or DC to AC conversion may be included in the floor-mounted charging interface 510, as needed. Moreover, in some cases, the

As discussed above, the controller 300 may be used to power all of the switchable viewing panes 200 to provide transparency to all of the switchable viewing panes 200 as shown in FIG. 5A. However, the controller 300 may alternatively be used to remove power from all of the switchable viewing panes 200 to provide opacity to all of the switchable viewing panes 200 as shown in FIG. 5B. Other specific control options are also possible including the provision of all of the switchable viewing panes 200 of some sections on, whereas all of the switchable viewing panes 200 of other sections are off. FIG. 5C illustrates such an example. In this regard, all of the switchable viewing panes of the first section 502, the third section 506 and the fourth section 508 are shown as opaque (e.g., powered off), whereas all of the switchable viewing panes of the second section 504 are shown as transparent (e.g., powered on). Other patterns or even individual control of respective individual ones of the switchable viewing panes are also achievable as shown in FIG. 5D.

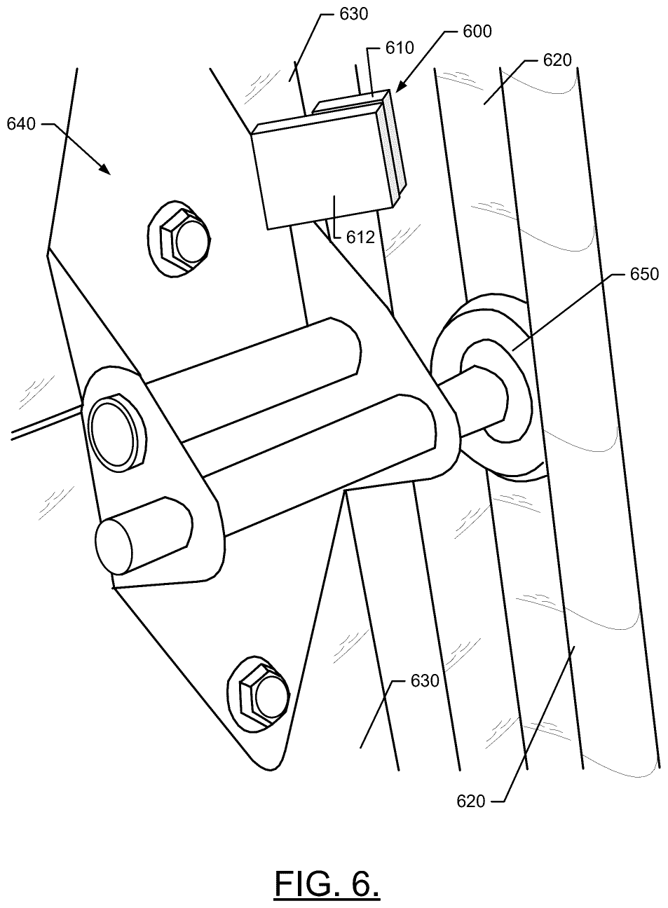

Although FIGS. 5A to 5D show charging via a floor-mounted assembly, other alternatives may also be provided. In this regard, for example, FIG. 6 illustrates a perspective view of a rail-mounted charging interface 600 for a switchable viewing pane control system in accordance with an example embodiment. In the example of FIG. 6, the rail-mounted charging interface 600 includes a charging pad 610 and charge adapter 612 similar to those discussed above in reference to FIG. 5A except that the charging pad 610 is attached to a rail 620 and the charge adapter 612 is attached to a section 630 of the sectional door and/or to a door hinge 640, which may further operably couple a roller 650 to the rail 620. The charging pad 610 and charge adapter 612 may be brought into proximity with each other when, for example, the sectional door is in the closed position for charging as discussed above. However, rather than being on a high traffic area that may collect dust and debris, such as the floor-mounted charging interface 510, one or more instances of the rail-mounted charging interface 600 may be placed at any point along the rail 620 (including vertical portions thereof) to permit charging so that even open door charging may be possible. In some cases, each section of the sectional door may have its own instance of the rail-mounted charging interface 600 to charge a corresponding local instance of the battery 310 for that section.

Accordingly, some example embodiments may provide a sectional door with switchable viewing properties. The sectional door may include a plurality of door sections including at least a top section and a bottom section, a hinge assembly operably coupling adjacent door sections to each other to enable the adjacent door sections to pivot relative to each other via the hinge assembly, a roller assembly operably coupling the door sections to a rail assembly to enable the sectional door to transition between an open state and a closed state via the roller assembly carrying the sectional door in the rail assembly, and a switchable viewing pane that transitions between a transparent state and an opaque or translucent state responsive to receipt of a transition signal, the switchable viewing pane being disposed at a portion of one of the door sections.

The sectional door and/or a system including the same, or components thereof described above may be augmented or modified by altering individual features mentioned above or adding optional features. In this regard, for example, the switchable viewing pane may include a liquid crystal layer that is transparent with power applied and translucent or opaque when power is not applied, and power may be applied responsive to receipt of the transition signal. In an example embodiment, the transition signal is generated by a controller in wired or wireless communication with the switchable viewing pane. In some cases, the transition signal is generated by a remote computer in communication with the switchable viewing pane, and the remote computer generates a control console or web page via which a user interfaces with the remote computer to generate the transition signal. In an example embodiment, the control console or web page further enables the user to select a schedule for future transmission of the transition signal. In some cases, the switchable viewing pane may be one of a plurality of switchable viewing panes. In such cases, all of the switchable viewing panes may be provided with the transition signal simultaneously to enable all of the switchable viewing panes to transition between the transparent state and the opaque or translucent state simultaneously. Alternatively or additionally, the transition signal may be provided by a controller to one or more of the plurality of switchable viewing panes on an individual basis. In some cases, the transition signal may be provided by a controller to a pattern of individual ones of the plurality of switchable viewing panes, and the a pattern may be a predetermined pattern or a user defined pattern. In an example embodiment, the transition signal may be provided by a controller to a group of panes among the plurality of switchable viewing panes. In some cases, the switchable viewing pane may be powered by a battery. The battery may be rechargeable, and the battery may be charged via a floor-mounted charging interface including a charging pad disposed at the floor, and a charge adapter disposed at the bottom section of the sectional door or alternatively the battery may be charged via a rail-mounted charging interface including a charging pad disposed at a rail in which rollers of the roller assembly are movable, and a charge adapter disposed at one or more of the door sections of the sectional door. In some cases, the switchable viewing pane is powered by mains power, battery power, wireless power, or energy harvesting.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A sectional door comprising:
a plurality of door sections including at least a top section and a bottom section;
a hinge assembly operably coupling adjacent door sections to each other to enable the adjacent door sections to pivot relative to each other via the hinge assembly;
a roller assembly operably coupling the door sections to a rail assembly to enable the sectional door to transition between an open state and a closed state via the roller assembly carrying the sectional door in the rail assembly; and
a switchable viewing pane that transitions between a transparent state and an opaque or translucent state responsive to receipt of a transition signal, the switchable viewing pane being disposed at a portion of one of the door sections.

2. The sectional door of claim 1, wherein the switchable viewing pane comprises a liquid crystal layer that is transparent with power applied and translucent or opaque when power is not applied, and
wherein power is applied responsive to receipt of the transition signal.

3. The sectional door of claim 1, wherein the transition signal is generated by a controller in wired communication with the switchable viewing pane.

4. The sectional door of claim 1, wherein the transition signal is generated by a controller in wireless communication with the switchable viewing pane.

5. The sectional door of claim 1, wherein the transition signal is generated by a remote computer in communication with the switchable viewing pane, and
wherein the remote computer generates a control console or web page via which a user interfaces with the remote computer to generate the transition signal.

6. The sectional door of claim 5, wherein the control console or web page further enables the user to select a schedule for future transmission of the transition signal.

7. The sectional door of claim 1, wherein the switchable viewing pane is one of a plurality of switchable viewing panes.

8. The sectional door of claim 7, wherein all of the switchable viewing panes are provided with the transition signal simultaneously to enable all of the switchable viewing panes to transition between the transparent state and the opaque or translucent state simultaneously.

9. The sectional door of claim 7, wherein the transition signal is provided by a controller to one or more of the plurality of switchable viewing panes on an individual basis.

10. The sectional door of claim 7, the transition signal is provided by a controller to a pattern of individual ones of the plurality of switchable viewing panes, and
wherein the a pattern is a predetermined pattern or a user defined pattern.

11. The sectional door of claim 7, wherein the transition signal is provided by a controller to a group of panes among the plurality of switchable viewing panes.

12. The sectional door of claim 1, wherein the switchable viewing pane is powered by a battery.

13. The sectional door of claim 12, wherein the battery is rechargeable, and
wherein the battery is charged via a floor-mounted charging interface including a charging pad disposed at the floor, and a charge adapter disposed at the bottom section of the sectional door.

14. The sectional door of claim 12, wherein the battery is rechargeable, and
wherein the battery is charged via a rail-mounted charging interface including a charging pad disposed at a rail in which rollers of the roller assembly are movable, and a charge adapter disposed at one or more of the door sections of the sectional door.

15. The sectional door of claim 1, wherein the switchable viewing pane is powered by mains power, battery power, wireless power, or energy harvesting.

16. A garage door operator (GDO) system comprising:
a sectional door movable on rails between an open position and a closed position; and
a motorhead operable to provide power for movement of the sectional door between the open and closed positions,
wherein the sectional door comprises:
a plurality of door sections including at least a top section and a bottom section;
a hinge assembly operably coupling adjacent door sections to each other to enable the adjacent door sections to pivot relative to each other via the hinge assembly;
a roller assembly operably coupling the door sections to the rails to enable the sectional door to transition between the open position and the closed position via the roller assembly carrying the sectional door in the rails; and
a switchable viewing pane that transitions between a transparent state and an opaque or translucent state responsive to receipt of a transition signal, the switchable viewing pane being disposed at a portion of one of the door sections.

17. The GDO system of claim 16, wherein the switchable viewing pane comprises a liquid crystal layer that is transparent with power applied and translucent or opaque when power is not applied,
wherein power is applied responsive to receipt of the transition signal,
wherein the transition signal is generated by a controller in wired or wireless communication with the switchable viewing pane.

18. The GDO system of claim 16, wherein the switchable viewing pane is one of a plurality of switchable viewing panes,
wherein all of the switchable viewing panes are provided with the transition signal simultaneously to enable all of the switchable viewing panes to transition between the transparent state and the opaque or translucent state simultaneously, or
wherein the transition signal is provided by a controller to one or more of the plurality of switchable viewing panes on a group or individual basis so that selected panes are transitioned.

19. The GDO system of claim 16, wherein the switchable viewing pane is powered by a battery.

20. The GDO system of claim 19, wherein the battery is rechargeable, and
wherein the battery is charged via a charging interface that is floor-mounted or rail-mounted.
